(19) United States
(12) Patent Application Publication
(10) Pub. No.: US 2021/0192402 A1
(43) Pub. Date: Jun. 24, 2021

(54) ABNORMAL TRIP MONITOR

(71) Applicant: Beijing DiDi Infinity Technology and Development Co., Ltd., Beijing (CN)

(72) Inventor: Haocheng ZHANG, Mountain View, CA (US)

(21) Appl. No.: 16/722,375

(22) Filed: Dec. 20, 2019

(51) Int. Cl. G06Q 10/06; G06Q 10/02; G08G 1/00; G06Q 30/00

(52) U.S. Cl. CPC G06Q 10/0633; G06Q 10/06395; G06Q 30/016; G06Q 10/02; G08G 1/202; G06Q 10/06393

(57) ABSTRACT

Trips on a ride sharing platform may be monitored in order to predict abnormal trips. A set of fixed features may be obtained based on a trip on a ride sharing platform. A set of dynamic features may be obtained based on the trip on the ride sharing platform. The set of fixed features and the set of dynamic features may be input into a prediction model. The trip on the ride sharing platform may be classified based on an output of the prediction model. An action may be performed based on the classification of the trip on the ride sharing platform.

### TECHNICAL FIELD

The disclosure relates generally to monitoring the status of a trip on a ride sharing platform, and more specifically to determining if the trip is abnormal.

### BACKGROUND

Under traditional approaches, ridesharing platforms may be able to connect passengers and drivers on relatively short notice. However, traditional ridesharing platforms suffer from a variety of safety and security risks for both passengers and drivers. Ridesharing platforms may have difficulty detecting an occurrence of an incident and/or timely responding to an incident. For example, if either a passenger's or driver's phone is stolen, the they may be unable to detect the incident and/or may be unable to timely report the incident.

### SUMMARY

Various embodiments of the specification include, but are not limited to, systems, methods, and non-transitory computer readable media for trip monitoring.

In various implementations, a method may include obtaining a set of fixed features and obtaining a set of dynamic features. The set of fixed features and the set of dynamic features may be based on a trip on a ride sharing platform. The method may further include inputting the set of fixed features and the set of dynamic features into a prediction model. The trip on the ride sharing platform may be classified based on an output of the prediction model. The method may further include performing an action based on the classification of the trip on the ride sharing platform.

In another aspect of the present disclosure, a computing system may comprise one or more processors and one or more non-transitory computer-readable memories coupled to the one or more processors and configured with instructions executable by the one or more processors. Executing the instructions may cause the system to perform operations. The operations may include obtaining a set of fixed features and obtaining a set of dynamic features. The set of fixed features and the set of dynamic features may be based on a trip on a ride sharing platform. The operations may further include inputting the set of fixed features and the set of dynamic features into a prediction model. The trip on the ride sharing platform may be classified based on an output of the prediction model. The operations may further include performing an action based on the classification of the trip on the ride sharing platform.

Yet another aspect of the present disclosure is directed to a non-transitory computer-readable storage medium configured with instructions executable by one or more processors to cause the one or more processors to perform operations. The operations may include obtaining a set of fixed features and obtaining a set of dynamic features. The set of fixed features and the set of dynamic features may be based on a trip on a ride sharing platform. The operations may further include inputting the set of fixed features and the set of dynamic features into a prediction model. The trip on the ride sharing platform may be classified based on an output of the prediction model. The operations may further include performing an action based on the classification of the trip on the ride sharing platform.

In some embodiments, the set of fixed features may include passenger information, driver information, and/or order information.

In some embodiments, the order information may include estimated trip duration, estimated trip distance, and/or payment type.

In some embodiments, the set of dynamic features may include time information, distance information, and/or trip status information.

In some embodiments, the time information may include a current duration of the trip, a ratio between the current duration of the trip and an estimated trip duration, and/or a current time.

In some embodiments, the trip status information may be based on a state machine.

In some embodiments, the output of the prediction model may be based on a comparison of the set of dynamic features with a set of predicted features.

In some embodiments, the trip on the ride sharing platform may be classified as successful, nominal, or abnormal.

In some embodiments, performing the action may include closing the trip on the ride sharing platform, creating a case report, contacting a passenger of the trip on the ride sharing platform, contacting a driver of the trip on the ride sharing platform, contacting emergency services, and/or contacting an emergency contact of the passenger of the trip on the ride sharing platform.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 illustrates an example environment to which techniques for trip monitoring may be applied, in accordance with various embodiments.

FIG. 2 illustrates an example state machine for trip monitoring, in accordance with various embodiments.

FIG. 3 illustrates a block diagram for trip monitoring, according to various embodiments of the present disclosure.

FIG. 4 illustrates a flowchart of an example method for trip monitoring, according to various embodiments of the present disclosure.

FIG. 5 is a block diagram that illustrates a computer system upon which any of the embodiments described herein may be implemented.

### DETAILED DESCRIPTION OF THE EMBODIMENTS

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

The approaches disclosed herein may improve the safety, security, and responsiveness (e.g., computational efficiency) of a ride sharing platform by actively monitoring trips. A predictive model may be used to predict how dangerous a trip is (e.g., a likelihood that a trip may have an incident, a level of severity of potential incidents, and/or the like). The prediction may be based on fixed features (e.g., obtained before the trip) and/or dynamic features (e.g., obtained during the trip). Based on the prediction from the predictive model, an action may be performed. An abnormal trip may indicate that an incident has occurred (e.g., an incident by a passenger against a driver, an incident by a driver against a passenger) and/or may occur soon. An incident may be a physical incident (e.g., property losses, physical harms to drivers or passengers). The safety of the ride sharing platform, and/or or other features of the ride sharing platform (e.g., computational efficiency), may be improved by responding to abnormal trips.

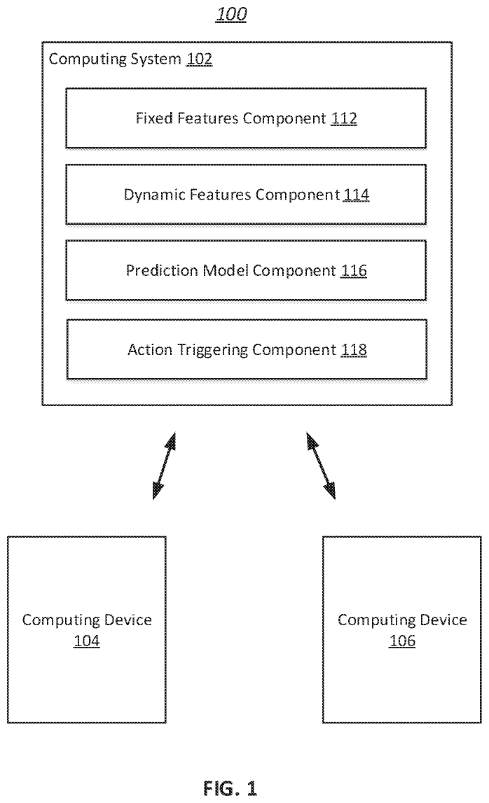

FIG. 1 illustrates an example environment 100 to which techniques for trip monitoring may be applied, in accordance with various embodiments. The example environment 100 may include a computing system 102, a computing device 104, and a computing device 106. It is to be understood that although two computing devices are shown in FIG. 1, any number of computing devices may be included in the environment 100. Computing system 102 may be implemented in one or more networks (e.g., enterprise networks), one or more endpoints, one or more servers, or one or more clouds. A server may include hardware or software which manages access to a centralized resource or service in a network. A cloud may include a cluster of servers and other devices which are distributed across a network.

The computing devices 104 and 106 may be implemented on or as various devices such as mobile phone, tablet, server, desktop computer, laptop computer, vehicle (e.g., car, truck, boat, train, autonomous vehicle, electric scooter, electric bike), etc. The computing system 102 may communicate with the computing devices 104 and 106, and other computing devices. Computing devices 104 and 106 communicate with each other through computing system 102, and may communicate with each other directly. Communication between devices may occur over the internet, through a local network (e.g., LAN), or through direct communication (e.g., BLUETOOTH™, radio frequency, infrared).

While the computing system 102 is shown in FIG. 1 as a single entity, this is merely for ease of reference and is not meant to be limiting. One or more components or one or more functionalities of the computing system 102 described herein may be implemented in a single computing device or multiple computing devices. The computing system 102 may include a fixed features component 112, a dynamic features component 114, a prediction model component 116, and an action triggering component 118. The computing system 102 may include other components. The computing system 102 may include one or more processors (e.g., a digital processor, an analog processor, a digital circuit designed to process information, a central processing unit, a graphics processing unit, a microcontroller or microprocessor, an analog circuit designed to process information, a state machine, and/or other mechanisms for electronically processing information) and memory (e.g., permanent memory, temporary memory). The processor(s) may be configured to perform various operations by interpreting machine-readable instructions stored in the memory. The computing system 102 may be installed with appropriate software (e.g., platform program, etc.) and/or hardware (e.g., wires, wireless connections, etc.) to access other devices of the environment 100.

The fixed features component 112 may be configured to obtain a set of fixed features. The set of fixed features may be based on a trip on a ride sharing platform. For example, the fixed features may be obtained in response to a request for a trip. Obtaining information may include one or more of accessing, acquiring, analyzing, determining, examining, identifying, loading, locating, opening, receiving, retrieving, reviewing, storing, or otherwise obtaining the information. A user may order a trip through a ride sharing platform. Multiple recommended routes may be generated for each trip request in the ride sharing platform. A driver may be allowed to choose a route from the list of recommended routes. In some embodiments, routes may be recommended based on the shortest distance or travel time from a starting point to a destination. In some embodiments, the starting point may be based on a location of a mobile device of the user requesting the route. In some embodiments, the starting point may be selected by the user through the ride sharing platform. In some embodiments, the destination may be selected by the user through the ride sharing platform. In some embodiments, the set of fixed features may be consistent throughout the trip.

In some embodiments, the set of fixed features may include passenger information, driver information, and/or order information. The passenger information and driver information may include a number of finished orders, a number of cancelled orders, an order cancel ratio, whether the user has two consecutive trips in a short time (e.g., 10 minutes, one hour), a number finished orders in one hour, and how long the user has been registered on the ridesharing platform (e.g., 30 days). In some embodiments, the order information may include estimated trip duration, estimated trip distance, and payment type (e.g., cash, electronic). In some embodiments, the order information may include weather (raining, snowing, clear, temperature), time of day (6:01 am, 9:00 μm, morning, night), road condition (wet, icy, flooded, clear), construction, and preexisting accidents.

The dynamic features component 114 may be configured to obtain a set of dynamic features. The set of dynamic features may be based on a trip on a ride sharing platform, and may change throughout the trip. In some embodiments, the set of dynamic features may include time information, distance information, and/or trip status information. In some embodiments, the time information may include a current duration of the trip, a ratio between the current duration of the trip and an estimated trip duration, and a current time (e.g., current hour). In some embodiments, the distance information may include a current distance traveled on the trip, and a ratio between the current distance of the trip and an estimated trip distance. In some embodiments, the set of dynamic features may be based on external factors which occur during the trip. For example, the set of dynamic features may include a road closure, traffic, or a recent car accident along the recommended route. In some embodiments, the trip status information may be based on a state machine. For example, the state machine may be used to determine a current status of the trip.

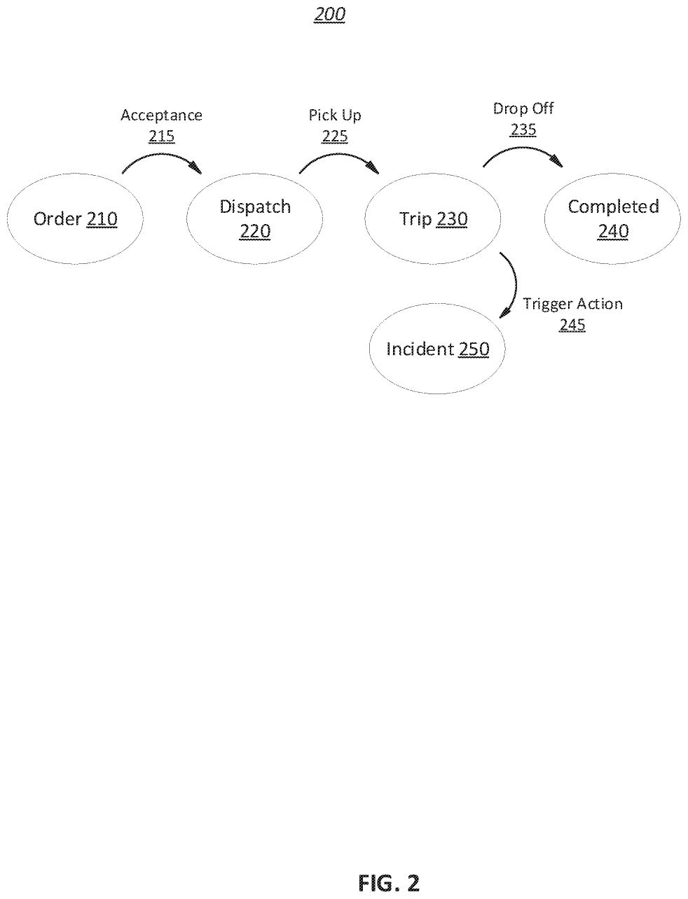

FIG. 2 illustrates an example state machine 200 for trip monitoring, in accordance with various embodiments. In some embodiments, the state machine may be implemented by the dynamic features component 114 of FIG. 1. Order state 210 may begin after an order is received from a passenger. The ride sharing platform may match the passenger with a driver. If the driver does not accept the order, the passenger may be matched with a new driver. Once a driver accepts the order, the state machine may advance through acceptance transition 215 to dispatch state 220. At dispatch state 220, the driver may be routed to the passengers location. After the passenger is picked up at state 225, the state machine may advance to trip 230. During trip 230, the driver may be routed to the passenger's destination. If the passenger is dropped off at the destination at transition 235, then the state machine may transition to completed state 240. At complete state 240, the passenger may be charged, and the trip may be closed. If a trigger action occurs during the trip state 230, the state machine may branch at trigger action transition 245 to incident state 250. Incident state 250 may be reached for various reasons. For example, the driver may have forgotten to close the trip. In this example, customers services may close the trip in order to resolve the order. In another example, a crime may have occurred. In this example, the ride sharing platform may take further actions. Returning to FIG. 1, the dynamic features component 114 may obtain the state of the trip and any transitions from the state machine.

The prediction model component 116 may be configured to input the set of fixed features and the set of dynamic features into a prediction model. In some embodiments, the set of fixed features may be input into the prediction model after an order is placed and before the trip begins. In some embodiments, the set of dynamic features may be input into the prediction model in real time during a trip. In some embodiments, the prediction model may be trained with historical data in order to predict how dangerous a trip is. For example, the prediction model may determine that electronic payment (e.g., credit card) is safer than cash, that longer trips are more dangerous, and that night trips are more dangerous. In some embodiments, the prediction model may include a random decision forest model. For example, training the prediction model may include constructing a set of decision trees. Each individual decision tree may generate a prediction. The output of the prediction model may include as prediction distribution based on the individual trees. The prediction distribution may include a mean and standard deviation of predictions from each individual tree.

The prediction model component 116 may be configured to classify the trip on the ride sharing platform based on an output of the prediction model. In some embodiments, the output of the prediction model may be based on a comparison of the set of dynamic features with a set of predicted features. In some embodiments, the prediction model may learn the states and transitions of state machine 200 of FIG. 2 based on historical trips. For example, a state or transition may be input into the model along with time and distance information. The current state of the trip may be compared with a time and distance prediction. The prediction model may output a probability distribution of an incident occurring.

In some embodiments, the trip on the ride sharing platform may be classified as successful, nominal, or abnormal. The trip may be classified as a successful trip after the passenger is dropped off at the destination. The trip may be classified as a nominal trip while the trip is ongoing, and prediction model outputs a low probability of an incident. The trip may be classified as a abnormal trip if the probability output by the prediction model is greater than a threshold amount. In some embodiments, the classification of the trip may include a score based on how dangerous the trip is predicted to be. For example, the inputs to the prediction model trip may include a trip at night (e.g., start_hour in (20 pm-6 am)), a cash order: (e.g., pay_type=1024), a trip with a specific status, a time ratio greater than a threshold (e.g., time_ratio>=2.1), a distance ratio greater than a threshold (e.g., distance_ratio>=1.2), a user (e.g., passenger, driver) order cancel ratio greater than a threshold, and a user (e.g., passenger, driver) with few complete orders. Each of these inputs may increase the likelihood of a dangerous trip. Based on the inputs, the prediction model may output a high probability of a dangerous trip.

The action triggering component 116 may be configured to perform an action based on the classification of the trip on the ride sharing platform. In some embodiments, performing the action may include closing the trip on the ride sharing platform, creating a case report, contacting a passenger of the trip on the ride sharing platform, contacting a driver of the trip on the ride sharing platform, contacting emergency services, and/or contacting an emergency contact of the passenger of the trip on the ride sharing platform. In some embodiments, the action may be based on how dangerous a trip is predicted to be. For example, a trip may begin at 1 am. The trip may be predicted to end at 1:16 am. At 1:32 am, the trip may be classified as an abnormal trip. In response to the classification, the drive may be contacted. If the driver does not respond, and the trip does not complete by 2 am, emergency services may be contacted.

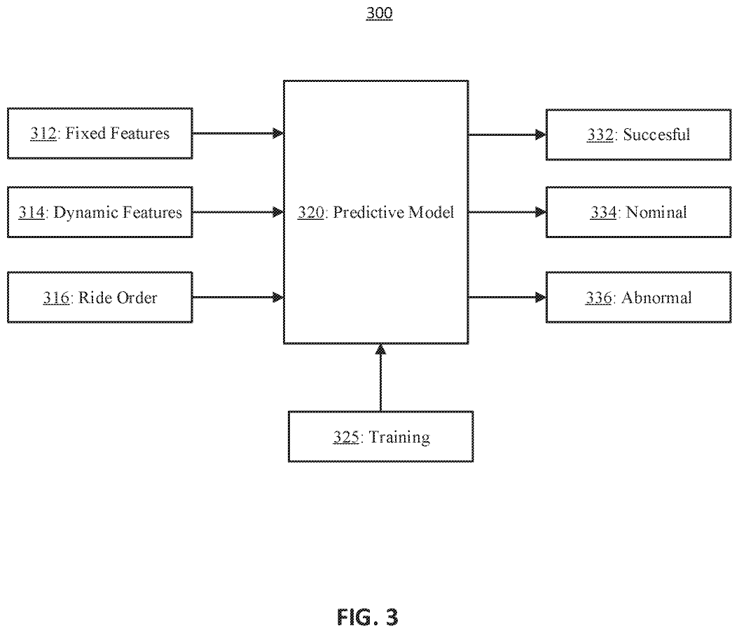

FIG. 3 illustrates a block diagram 300 for trip monitoring, according to various embodiments of the present disclosure. The block diagram 300 may be implemented in various environments including, for example, the environment 100 of FIG. 1. The operations of the block diagram 300 presented below are intended to be illustrative. Depending on the implementation, the block diagram 300 may include additional, fewer, or alternative blocks in various orders or in parallel. The block diagram 300 may be implemented in various computing systems or devices including one or more processors.

In some embodiments, a set of inputs may be collected, including fixed features 312, dynamic features 314, and ride order 316. The inputs may be fed into predictive model 320. In some embodiments, the predictive model 320 may be included in the prediction model component 116 of FIG. 1. In some embodiments, the prediction model may be trained by training block 325. For example, the prediction model may be trained offline based on historical ride order data. In another example, the prediction model may receive feedback in real time (e.g., every minute, every hour, every day) and updated based on the feedback. Based on the inputs and the training, the prediction model 320 may output trip classifications successful 332, nominal 334, and abnormal 336.

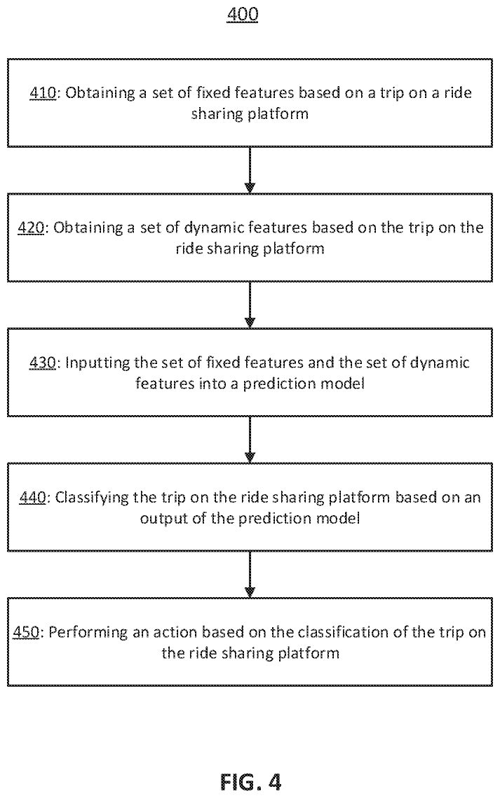

FIG. 4 illustrates a flowchart of an example method 400 for trip monitoring, according to various embodiments of the present disclosure. The method 400 may be implemented in various environments including, for example, the environment 100 of FIG. 1. The operations of the method 400 presented below are intended to be illustrative. Depending on the implementation, the method 400 may include additional, fewer, or alternative steps performed in various orders or in parallel. The method 400 may be implemented in various computing systems or devices including one or more processors.

With respect to the method 400, at block 410, a set of fixed features may be obtained based on a trip on a ride sharing platform. At block 420, a set of dynamic features may be obtained based on the trip on the ride sharing platform. At block 430, the set of fixed features and the set of dynamic features may be input into a prediction model. At block 440, the trip on the ride sharing platform may be classified based on an output of the prediction model. At block 450, an action may be performed based on the classification of the trip on the ride sharing platform.

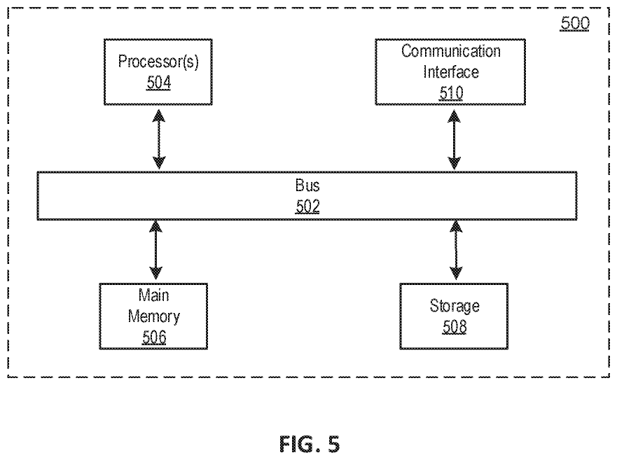

FIG. 5 is a block diagram that illustrates a computer system 500 upon which any of the embodiments described herein may be implemented. For example, the computer system 500 may be any one of the computing system 102 and the computing devices 104 and 106. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor(s) 504. Main memory 506 also may be used for storing temporary variables or other intermediate information during execution of instructions to be executed by processor(s) 504. Such instructions, when stored in storage media accessible to processor(s) 504, render computer system 500 into a special-purpose machine that is customized to perform the operations specified in the instructions. Main memory 506 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 508. Execution of the sequences of instructions contained in main memory 506 causes processor(s) 504 to perform the process steps described herein.

For example, the computing system 500 may be used to implement computing system 102, computing device 104, and computing device 106 shown in FIG. 1. In another example, the computing system 500 may be used to implement the one or more components of the computing system 102 shown in FIG. 1. As another example, the process/method shown in FIG. 2, FIG. 3, FIG. 4, and described in connection with this figure may be implemented by computer program instructions stored in main memory 506. When these instructions are executed by processor(s) 504, they may perform the steps as shown in FIG. 2 FIG. 3, and FIG. 4, and described above. In alternative embodiments, hard-wired circuitry may be used in place of or in combination with software instructions.

The computer system 500 also includes a communication interface 510 coupled to bus 502. Communication interface 510 provides a two-way data communication coupling to one or more network links that are connected to one or more networks. As another example, communication interface 510 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner). As used herein, for convenience, components of the computing system 110 may be described as performing or configured for performing an operation, when the components may comprise instructions which may program or configure the computing system 110 to perform the operation.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A method for trip monitoring, comprising:
obtaining a set of fixed features based on a trip on a ride sharing platform;
obtaining a set of dynamic features based on the trip on the ride sharing platform;
inputting the set of fixed features and the set of dynamic features into a prediction model;
classifying the trip on the ride sharing platform based on an output of the prediction model; and
performing an action based on the classification of the trip on the ride sharing platform.

2. The method of claim 1, wherein the set of fixed features comprise at least one of:
passenger information, driver information, and order information.

3. The method of claim 2, wherein the order information comprises at least one of:
estimated trip duration, estimated trip distance, and payment type.

4. The method of claim 1, wherein the set of dynamic features comprise at least one of:
time information, distance information, and trip status information.

5. The method of claim 4, wherein the time information comprises at least one of: a current duration of the trip, a ratio between the current duration of the trip and an estimated trip duration, and a current time.

6. The method of claim 4, wherein the trip status information is based on a state machine.

7. The method of claim 1, wherein the output of the prediction model is based on a comparison of the set of dynamic features with a set of predicted features.

8. The method of claim 1, wherein the trip on the ride sharing platform is classified as at least one of: successful, nominal, or abnormal.

9. The method of claim 1, wherein performing the action comprises at least one of:
closing the trip on the ride sharing platform;
creating a case report;
contacting a passenger of the trip on the ride sharing platform;
contacting a driver of the trip on the ride sharing platform;
contacting emergency services; and
contacting an emergency contact of the passenger of the trip on the ride sharing platform.

10. A system for trip monitoring, comprising one or more processors and one or more non-transitory computer-readable memories coupled to the one or more processors and configured with instructions executable by the one or more processors to cause the system to perform operations comprising:
obtaining a set of fixed features based on a trip on a ride sharing platform;
obtaining a set of dynamic features based on the trip on the ride sharing platform;
inputting the set of fixed features and the set of dynamic features into a prediction model;
classifying the trip on the ride sharing platform based on an output of the prediction model; and
performing an action based on the classification of the trip on the ride sharing platform.

11. The system of claim 10, wherein the set of fixed features comprise at least one of:
passenger information, driver information, and order information.

12. The system of claim 11, wherein the order information comprises at least one of:
estimated trip duration, estimated trip distance, and payment type.

13. The system of claim 10, wherein the set of dynamic features comprise at least one of:
time information, distance information, and trip status information.

14. The system of claim 13, wherein the time information comprises at least one of: a current duration of the trip, a ratio between the current duration of the trip and an estimated trip duration, and a current time.

15. The system of claim 13, wherein the trip status information is based on a state machine.

16. The system of claim 10, wherein the output of the prediction model is based on a comparison of the set of dynamic features with a set of predicted features.

17. The system of claim 10, wherein the trip on the ride sharing platform is classified as at least one of: successful, nominal, or abnormal.

18. The system of claim 10, wherein performing the action comprises at least one of:
closing the trip on the ride sharing platform;
creating a case report;
contacting a passenger of the trip on the ride sharing platform;
contacting a driver of the trip on the ride sharing platform;
contacting emergency services; and
contacting an emergency contact of the passenger of the trip on the ride sharing platform.

19. A non-transitory computer-readable storage medium configured with instructions executable by one or more processors to cause the one or more processors to perform operations comprising:
obtaining a set of fixed features based on a trip on a ride sharing platform;
obtaining a set of dynamic features based on the trip on the ride sharing platform;
inputting the set of fixed feature and the set of dynamic features into a prediction model;
classifying the trip on the ride sharing platform based on an output of the prediction model; and
performing an action based on the classification of the trip on the ride sharing platform.

20. The non-transitory computer-readable storage medium of claim 19, wherein the set of dynamic features comprise at least one of: time information, distance information, and trip status information.
